(19) United States
(12) Patent Application Publication
(10) Pub. No.: US 2023/0110039 A1
(43) Pub. Date: Apr. 13, 2023

(54) NUCLEAR REACTOR AND CONTROL METHOD FOR NUCLEAR REACTOR

(71) Applicant: MITSUBISHI HEAVY INDUSTRIES, LTD., Tokyo (JP)

(72) Inventors: Wataru Nakazato, Tokyo (JP); Hideaki Ikeda, Tokyo (JP); Takashi Hasegawa, Tokyo (JP); Nozomu Murakami, Tokyo (JP); Tadakatsu Yodo, Tokyo (JP); Shohei Otsuki, Tokyo (JP); Satoru Kamohara, Tokyo (JP); Shota Kobayashi, Tokyo (JP); Yasutaka Harai, Tokyo (JP); Yutaka Tanaka, Tokyo (JP); Takafumi Noda, Tokyo (JP); Kazuhiro Yoshida, Tokyo (JP); Hideyuki Sakata, Tokyo (JP); Hironori Noguchi, Tokyo (JP); Hideyuki Kudo, Tokyo (JP); Tatsuo Ishiguro, Tokyo (JP)

(73) Assignee: MITSUBISHI HEAVY INDUSTRIES, LTD., Tokyo (JP)

(21) Appl. No.: 17/802,353

(22) PCT Filed: Oct. 19, 2020
(86) PCT No.: PCT/JP2020/039284

§ 371 Date: Aug. 25, 2022

(30) Foreign Application Priority Data
Feb. 28, 2020 (JP) 2020-033419

(51) Int. Cl. G21C 15/02; G21C 7/08; G21C 7/32; G21C 11/06

(52) U.S. Cl. CPC G21C 15/02; G21C 7/08; G21C 7/32; G21C 11/06

(57) ABSTRACT

Heat can be stably extracted with easy criticality control. A nuclear reactor includes: a fuel portion being a reactor core having a nuclear fuel body; a shielding portion covering all over outer sides of the fuel portion to shield against radiations generated from the reactor core; and a thermal conduction part that conducts heat generated in the reactor core to exterior of the shield part. The nuclear fuel body contains a fissile material with an enrichment not less than 5% by weight throughout an operation period.

### FIELD

The present disclosure relates to a nuclear reactor and a control method for a nuclear reactor.

### BACKGROUND

A nuclear power generation system, which uses a nuclear fuel body and generates power with heat generated from burnup, is configured to generate power by: recovering, with coolant circulated, the heat generated in the nuclear reactor; generating steam using the recovered heat; and rotating a turbine with the steam. Patent Literatures 1 and 2 disclose techniques for recovering heat generated in a nuclear reactor with heat pipes.

### CITATION LIST

### Patent Literature

Patent Literature 1: Specification of U.S. Pat. No. 2016/0027536
Patent Literature 2: Publication of Japanese Translation of PCT Application No. 2019-531472

### SUMMARY

### Technical Problem

A light-water nuclear reactor, which uses light water as a moderator for neutrons, is configured to extract heat while controlling the criticality of the nuclear reactor with control rods and additives such as boron in order to prevent reactivity from decreasing due to the high power output thereof. That is, the light-water nuclear reactor needs various kinds of control to enable stable extraction of heat.

The present disclosure has been intended to address the above difficulties and an object thereof is to provide a nuclear reactor and a controlling method for a nuclear reactor that enable stable extraction of heat with easy criticality control.

### Solution to Problem

To achieve the above-mentioned object, a nuclear reactor according to an aspect of the present disclosure includes: a reactor core having a nuclear fuel body; a shielding portion that covers all over outer sides of the reactor core to shield against radiations generated from the reactor core; and a thermal conduction part that transfers heat generated in the reactor core to exterior of the shielding portion. The nuclear fuel body contains a fissile material with a weight density of not less than 5% by weight throughout an operation period.

To achieve the above-mentioned object, a nuclear reactor according to an aspect of the present disclosure includes: a reactor core having a nuclear fuel body; a shielding portion that covers all over outer sides of the reactor core to shield against radiations generated from the reactor core; and a thermal conduction part that transfers heat generated in the reactor core to exterior of the shielding portion. Throughout an operation period, an operation cycle is continued according to decrease of fission reactions due to neutron capture in a resonance region after a temperature of the nuclear fuel body increases to a certain value, the operation cycle continuing until the temperature of the nuclear fuel body decreases to a certain value.

To achieve the above-mentioned object, a nuclear reactor according to an aspect of the present disclosure performs criticality control solely with a decrease in temperature of a reactor core due to the Doppler effect throughout an operation period.

To achieve the above-mentioned object, a control method for a nuclear reactor according to an aspect of the present disclosure includes controlling criticality throughout an operation period in such a manner as to maintain constant criticality by lowering a reactor core temperature of a reactor core having a nuclear fuel body.

### Advantageous Effects of Invention

According to this disclosure, heat can be extracted stably with easy criticality control.

### BRIEF DESCRIPTION OF DRAWINGS

FIG. 1 is a schematic diagram of a nuclear power generation system including a nuclear reactor according to an embodiment.

FIG. 2 is a schematic view of the nuclear reactor according to the embodiment.

FIG. 3 is a schematic sectional view of the nuclear reactor according to the embodiment.

FIG. 4 is an enlarged, partially cut-out schematic view of the nuclear reactor according to the embodiment.

FIG. 5 is an enlarged, partially cut-out schematic view of the nuclear reactor according to the embodiment.

FIG. 6 is a time diagram illustrating control on the nuclear reactor according to the embodiment.

FIG. 7 is a flowchart diagram illustrating the control on the nuclear reactor according to the embodiment.

FIG. 8 is a flowchart diagram illustrating the control on the nuclear reactor according to the embodiment.

### DESCRIPTION OF EMBODIMENTS

The following describes an embodiment according to the present disclosure in detail based on the drawings. This disclosure is not limited by this embodiment. Components in the embodiment described below include those replaceable and easily conceivable by the skilled person or those identical in effect.

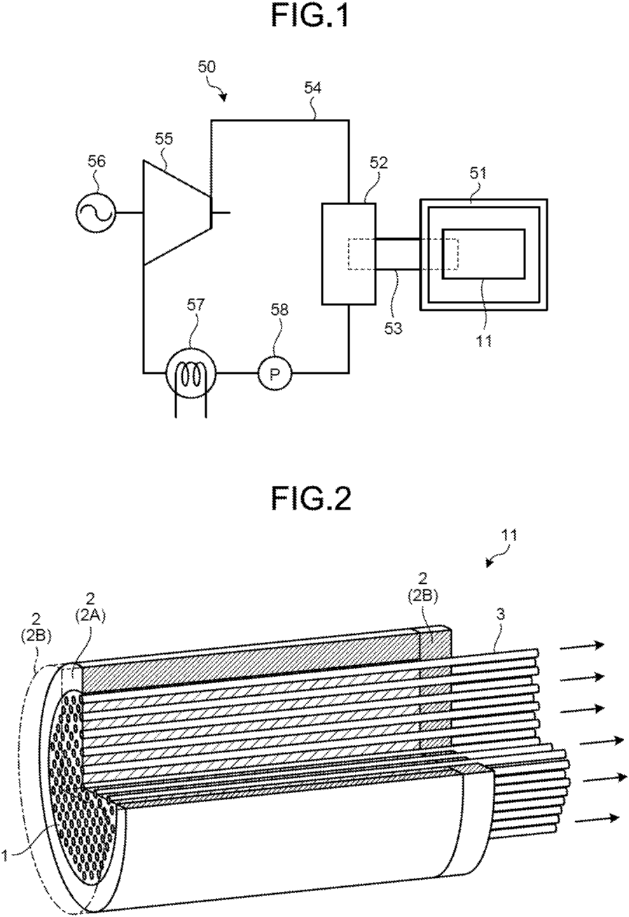

FIG. 1 is a schematic diagram of a nuclear power generation system including a nuclear reactor according to the embodiment. As illustrated in FIG. 1, a nuclear power generation system 50 includes a nuclear reactor vessel 51, a heat exchanger 52, a thermal conduction part 53, coolant circulation means 54, a turbine 55, a generator 56, a cooler 57, and a compressor 58.

The nuclear reactor vessel 51 includes a nuclear reactor 11 according to the present embodiment described below. The nuclear reactor vessel 51 has the nuclear reactor 11 internally housed therein. The nuclear reactor vessel 51 has the nuclear reactor 11 hermetically housed therein. The nuclear reactor vessel 51 has an opening in the form of, for example, a lid so that the nuclear reactor 11 internally placed therein can be housed therein or removed therefrom. The nuclear reactor vessel 51 can remain hermetically housed even when the interior thereof is at high temperature and high pressure after burnup occurs in the nuclear reactor 11. The nuclear reactor vessel 51 is formed of a material, such as concrete, for example, having a shielding property against neutron rays and formed in a sufficient thickness that prevents neutron rays generated in the interior of the nuclear reactor vessel 51 from leaking to the exterior thereof. The materials for the nuclear reactor vessel 51 may include an element, such as boron, that has an excellent shielding property.

The heat exchanger 52 exchanges heat with the nuclear reactor 11. The heat exchanger 52 in the present embodiment recovers heat from the nuclear reactor 11 through a solid high-thermal conductivity material of the thermal conduction part 53 that is partly disposed in the interior of the nuclear reactor vessel 51. The thermal conduction part 53 illustrated in FIG. 1 is a schematic representation of thermal conduction parts 3 described below.

The coolant circulation means 54 is a pathway through which a coolant is circulated, and is connected to the heat exchanger 52, the turbine 55, the cooler 57, and the compressor 58. The coolant that flows through the coolant circulation means 54 flows through the heat exchanger 52, the turbine 55, the cooler 57, and the compressor 58 in order. The coolant that has passed the compressor 58 is supplied to the heat exchanger 52. Thus, the heat exchanger 52 exchanges heat between the solid high-thermal conductivity material of the thermal conduction part 53 and the coolant flowing through the coolant circulation means 54.

The turbine 55 receives the coolant that has passed through the heat exchanger 52. The turbine 55 is rotated by energy from the heated coolant. That is, the turbine 55 absorbs energy from the coolant by converting the energy of the coolant into rotational energy.

The generator 56 is connected to the turbine 55 and rotates integrally with the turbine 55. The generator 56 generates power by rotating together with the turbine 55.

The cooler 57 cools the coolant that has passed through the turbine 55. The cooler 57 is a condenser or the like when a chiller or the coolant is temporarily liquidized.

The compressor 58 is a pump that pressurizes the coolant.

The nuclear power generation system 50 transfers the heat generated by reactions of the nuclear fuel bodies (1A) in the nuclear reactor 11 through the thermal conduction part 53 to the heat exchanger 52. In the heat exchanger 52, the nuclear power generation system 50 heats the coolant flowing through the coolant circulation means 54 with heat from the high-thermal conductivity material of the thermal conduction part 53. That is, the coolant absorbs heat in the heat exchanger 52. In this way, the heat generated in the nuclear reactor 11 is recovered by the coolant. After being compressed by the compressor 58, the coolant is heated while passing through the heat exchanger 52, and rotates the turbine 55 with the compressed and heated energy. The coolant is then cooled to a reference condition in the cooler 57 and supplied to the compressor 58 again. Note that, when the heat exchanger 52, the coolant circulation means 54, the turbine 55, the generator 56, and the compressor 58 are replaced with thermoelectric devices or the like, the nuclear power generation system 50 can be used for power generation or hydrogen production using heat.

As described above, the nuclear power generation system 50 transfers heat, extracted from the nuclear reactor 11, through the high-thermal conductivity material to the coolant that serves as a medium for rotating the turbine 55. The nuclear reactor 11 can be thus isolated from the coolant that serves as a medium for rotating turbine 55, whereby the medium for rotating turbine 55 is less likely to be contaminated.

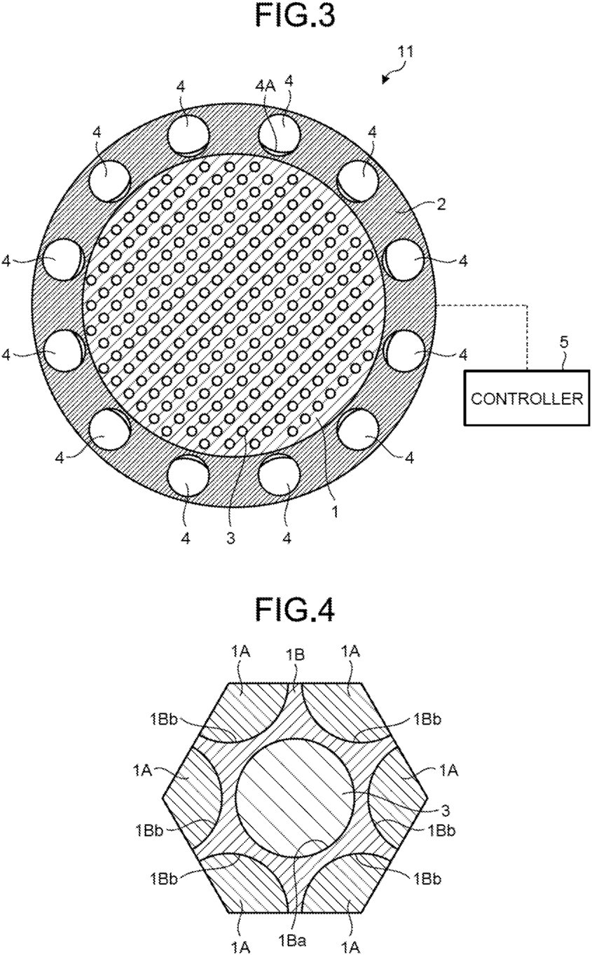

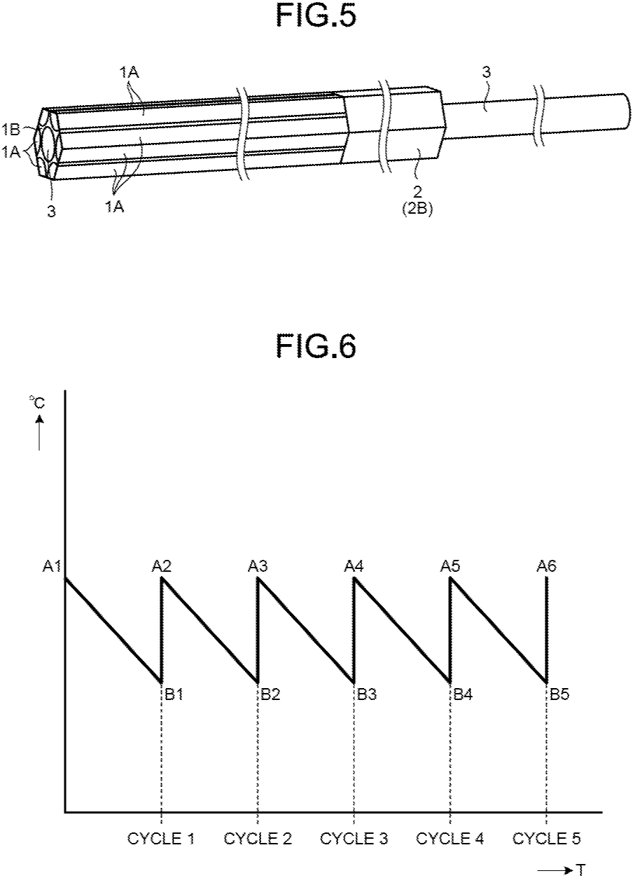

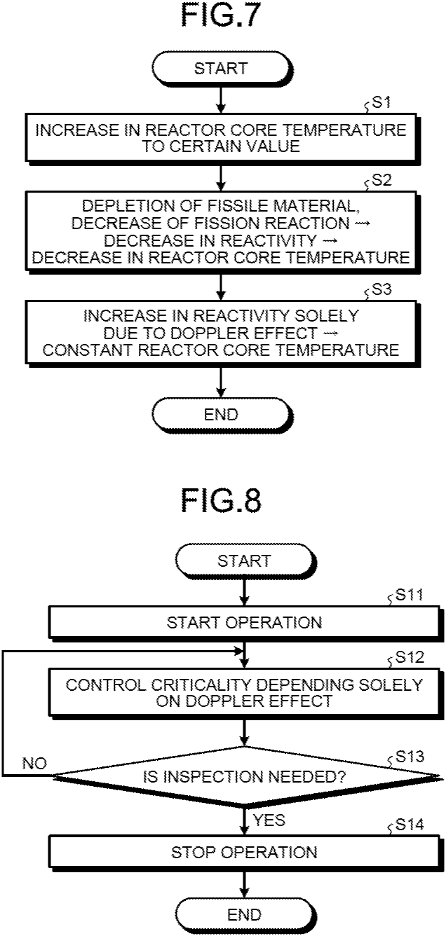

FIG. 2 is a schematic view of the nuclear reactor according to the embodiment. FIG. 3 is a schematic sectional view of the nuclear reactor according to the embodiment. FIG. 4 is an enlarged, partially cut-out schematic view of the nuclear reactor according to the embodiment. FIG. 5 is an enlarged, partially cut-out schematic view of the nuclear reactor according to the embodiment. FIG. 6 is a time diagram illustrating control on the nuclear reactor according to the embodiment. FIG. 7 is a flowchart diagram illustrating the control on the nuclear reactor according to the embodiment. FIG. 8 is a flowchart diagram illustrating the control on the nuclear reactor according to the embodiment.

As illustrated in FIGS. 2 to 5, the nuclear reactor 11 includes a fuel portion (reactor core) 1, a shielding portion 2, the thermal conduction parts 3, and control parts 4.

Nuclear fuel bodies 1A illustrated in FIGS. 4 and 5 are supported in the fuel portion 1. Although not explicitly illustrated, the fuel portion 1 is provided with control rods for controlling burnup of the nuclear fuel bodies 1A in such a manner that the control rods can be inserted into and retracted from the fuel portion 1. The fuel portion 1 suppresses burnup of the nuclear fuel bodies 1A when the control rods are inserted therein. In the fuel portion 1, the nuclear fuel bodies 1A burnup when the control rods are retracted from the fuel portion 1.

The fuel portion 1 is formed in a columnar shape as a whole. In the present embodiment, the fuel portion 1 is formed in a substantially cylindrical shape. A direction in which this cylindrical shape extends may also be referred to as the axial direction. Directions perpendicular to the axial direction may also be referred to as the radial directions. The fuel portion 1 includes the nuclear fuel bodies 1A and a support 1B as illustrated in FIGS. 4 and 5. FIGS. 4 and 5 are illustrations obtained by cutting the fuel portion 1 in FIG. 3 out into a columnar shape having a hexagonal section. A support 1B is formed so as to extend in the axial direction in such a manner as to form the same dimension as the fuel portion 1 in the axial direction of the columnar shape in which the fuel portion 1 is formed. The support 1B has insertion holes 1Ba formed therein in such a manner as to penetrate the support 1B in the axial direction. Rod-shaped thermal conduction parts 3 described below are inserted through the corresponding insertion holes 1Ba. In the present embodiment, each of the insertion holes 1Ba is formed in a circular sectional shape. The support 1B has holes 1Bb formed therein around each of the insertion holes 1Ba in such a manner as to penetrate the support 1B in the axial direction. The nuclear fuel bodies 1A are disposed in the insertion holes 1Ba. In the present embodiment, each of the holes 1Bb is formed in a circular sectional shape. The support 1B may contain, for example, graphene as a moderator. The support 1B may contain, for example, graphite as a moderator. In the present embodiment, so as to be disposed in the hole 1Bb in the support 1B, each of the nuclear fuel bodies 1A has a circular sectional shape and is formed in a rod shape continuous in the axial direction. The rod-shaped nuclear fuel body 1A can be formed by inserting pelletized nuclear fuel into the interior of a tube that has the above circular sectional shape. The nuclear fuel bodies 1A may contain, for example, uranium (such as uranium 235), plutonium (such as plutonium 239 or 241), or thorium as a fissile material.

The shielding portion 2 covers all over outer sides of the fuel portion 1. The shielding portion 2 is made of a metal block that reflects radiation (neutrons) radiated from the nuclear fuel bodies 1A, thereby preventing radiation leakage to the outside covering the fuel portion 1. The shielding portion 2 may also be referred to as a reflector depending on the neutron scattering and neutron absorption capabilities of a material used therefor.

The shielding portion 2 includes: a body 2A, which is cylindrically formed in the fuel portion 1 so as to enclose the entire outer circumference of the columnar shape of the fuel portion 1; and respective lids 2B that seal both ends of the body 2A. When housing the fuel portion 1 inside the shielding portion 2, it is preferable to fill the interior of the shielding portion 2 with an inert gas, such as nitriding gas, to prevent oxidation of the interior.

The thermal conduction parts 3 penetrates the shielding portion 2 to be inserted into the interior of the fuel portion 1 provided in the interior covered by the shielding portion 2, thereby being disposed in such a manner as to extend into the interior of the fuel portion 1 and into the exterior of the shielding portion 2. The thermal conduction parts 3 transfer heat generated from burnup of the nuclear fuel bodies 1A in the fuel portion 1 to the exterior of the shielding portion 2 by solid thermal conduction. For example, graphene may be used for the thermal conduction parts 3. For example, titanium, nickel, copper, or graphite may be used for the thermal conduction parts 3. Of each of the thermal conduction parts 3, a part extending into the exterior of the shielding portion 2 is provided so as to be able to exchange heat with the coolant in the interior of the nuclear reactor vessel 51.

The thermal conduction part 3 is formed in a rod shape extending in the axial direction. In the present embodiment, the thermal conduction part 3 is formed in a rod shape having a circular section. Each of the thermal conduction parts 3 is inserted into one of the insertion holes 1Ba formed in the support 1B in the fuel portion 1 and penetrates one of the lids 2B in the shielding portion 2 to be disposed so as to extend into the exterior of the shielding portion 2.

The control parts 4 are supported by the shielding portion 2. Two or more (12 in the present embodiment) of the control parts 4 are provided around the circumference of the column shape of the fuel portion 1. These two or more control parts 4 are evenly disposed around the circumference of the columnar shape of the fuel portion 1. Each of the control parts 4 has a cylindrical shape, that is, is formed in what is called a drum shape and extends in the axial direction, in which the columnar shape of the fuel portion 1 extends. The control part 4 is provided in such a manner as to be rotatable about the center of the cylindrical shape. The control part 4 has a neutron absorber 4A on a part of the outer circumference of the cylindrical shape. For example, boron carbide (B₄C) may be used for the neutron absorber 4A. The neutron absorber 4A is configured to be able to move close to and away from the fuel portion 1 being a reactor core, by making rotating movement with rotation of the control part 4. As the neutron absorber 4A moves closer to the fuel portion 1, the reactivity of the fuel portion 1 decreases; and, as the neutron absorber 4A moves further away from the fuel portion 1, the reactivity of the fuel portion 1 increases. Thus, the control part 4 can control the reactivity of the fuel portion 1 being the reactor core, and control the reactor core temperature of the fuel portion 1 by moving the neutron absorber 4A closer to or further away from the fuel portion 1. The reactor core temperature is the average reactor core temperature extracted to the exterior of the shielding portion 2 by the thermal conduction part 3.

The rotational movements of the control parts 4 are controlled by a controller 5. The controller 5 is, for example, a computer, and, although not explicitly illustrated in the drawings, implemented by an arithmetic processor including a microprocessor such as a central processing unit (CPU). The controller 5 can obtain the reactor core temperature of the fuel portion 1. The controller 5 controls the rotational positions of the control parts 4 to move the neutron absorbers 4A away from the fuel portion 1. The reactivity of the fuel portion 1 being the reactor core increases, whereby the nuclear reactor 11 starts operation. The controller 5 controls the rotational positions of the control parts 4 to move the neutron absorber 4A closer to the fuel portion 1. The reactivity of the fuel portion 1 being the reactor core then decreases, whereby the nuclear reactor 11 stops operation.

Therefore, in the nuclear reactor 11 in the present embodiment, heat generated from burnup of the nuclear fuel bodies 1A in the fuel portion 1 can be extracted to the exterior of the shielding portion 2 by solid thermal conduction of the thermal conduction parts 3. Subsequently, the heat extracted to the exterior of the shielding portion 2 is transferred to the coolant, thereby rotating the turbine 55.

The nuclear reactor 11 in the embodiment can extract heat from the nuclear fuel bodies 1A in the fuel portion 1 into the exterior of the shielding portion 2 by solid thermal conduction (see arrow in FIG. 2) of the thermal conduction part 3 and transfer the heat to the coolant. The nuclear reactor 11 in the embodiment can prevent leakage of radioactive substances and the like. In the nuclear reactor 11 in the embodiment, the thermal conduction parts 3 are disposed extending into the interior of the fuel portion 1 and into the exterior of the shielding portion 2. Therefore, heat from the nuclear fuel bodies 1A in the fuel portion 1 can be extracted to the exterior of the shielding portion 2 while distances for which the heat needs to be conducted is minimized. The nuclear reactor 11 according to the embodiment can ensure high output temperatures. In the nuclear reactor 11 of the present embodiment, the thermal conduction part 3 is described that has a form of extracting heat by solid thermal conduction, but another thermal conduction part may be used that has a form of extracting heat by fluid thermal conduction using heat pipes filled with fluid.

Here, the nuclear fuel bodies 1A are assumed to contain a fissile material with a weight density of not less than 5% by weight throughout each operation period of the nuclear reactor 11 in the present embodiment described above. Preferably, the nuclear fuel bodies 1A contain a fissile material with a weight density of not less than 15 % by weight in the nuclear reactor 11 in the present embodiment. More preferably, the nuclear fuel bodies 1A contain a fissile material with a weight density of not less than 15% by weight and not more than 20% by weight in the nuclear reactor 11 in the present embodiment. Furthermore, in the nuclear reactor 11 in the present embodiment, a temperature of the reactor core (average reactor core temperature) is set to be not less than 350° C. throughout each operation period of the nuclear reactor. In the nuclear reactor 11 in the present embodiment preferably, a reactor core temperature is not less than 500° C. and not more than 1,500° C. In the nuclear reactor 11 in the present embodiment, more preferably, a reactor core temperature is not less than 750° C. and not more than 1,500° C. The thermal output per volume of the nuclear fuel bodies 1A and each operation period are controlled so that the amount of the fissile material depleted due to operation is not more than one third of the amount of the fissile material at the start of operation. The nuclear reactor 11 in the present embodiment is preferably designed to control the thermal output per volume of the nuclear fuel bodies 1A and each operation period so that the amount of the fissile material depleted due to operation is not more than one fifth of the amount of the fissile material at the start of operation. The nuclear reactor 11 in the present embodiment is more preferably designed to control the thermal output per volume of the nuclear fuel bodies 1A and each operation period so that the amount of the fissile material depleted due to operation is not more than one tenth of the amount thereof at the start of operation.

The nuclear reactor 11 in the present embodiment as described above is subject to criticality control throughout each operation period from the start to stop of operation. That is, as illustrated in FIGS. 6 and 7, when operation is started, the nuclear reactor 11 has an increase in the reactivity of the fuel portion 1 being the reactor core, has an increase in the reactor core temperature (average reactor core temperature in °C) to a certain value (A1), and enters the critical state (step S1). At step S1, as neutron capture progresses in the resonance region due to the Doppler effect, the reactivity decreases, the fission reaction consequently decreases, and the reactor core temperature thereafter stays constant at a certain value. As time passes during an operation period T where the nuclear reactor 11 operates at output power P, the fissile material depletes, the fission reaction decreases, and the reactivity decreases, whereby the reactor core temperature decreases (step S2). Here, as the reactor core temperature decreases, positive reactivity is added as a result of feedback provided by the Doppler effect, resulting in heightened reactivity, whereby the reactor core temperature increases and then stays constant (A2: step S3). This ensures that criticality is constant, and the critical state is maintained. One operating cycle (such as Cycle 1) of the nuclear reactor 11 is defined as a period continuing until the reactor core temperature decreases to a certain value, for example, from the temperature A1 to the temperature B1, in accordance with the decrease of the fission reaction due to the neutron capture in the resonance region.

The nuclear reactor 11 in the present embodiment controls the rotational positions of the control parts 4 as described above when starting or stopping operation. Furthermore, the controller 5 of the nuclear reactor 11 controls the rotational positions of the control parts 4 in accordance with the reactor core temperature. Furthermore, the controller 5 of the nuclear reactor 11 obtains and averages reactor core temperatures, and controls the rotational positions of the control parts 4 when the average reactor core temperature is a certain temperature or lower. Specifically, as illustrated in FIG. 8, in the nuclear reactor 11, the controller 5 rotates the control parts 4 to bring the fuel portion 1 being the reactor core into the critical state when starting operation (step S11). The nuclear reactor 11 controls the criticality solely with a decrease in the reactor core temperature due to the Doppler effect throughout an operation period where the fuel portion 1 is in the critical state (step S12) (see the range from A1 to B1 in FIG. 6). That is, the controller 5 does not control the rotational positions of the control parts 4 at step S12. Thereafter, the reactivity of the nuclear fuel bodies 1A decreases as a result of the burnup thereof, whereby the reactor core temperature decreases even with the criticality control that depends on the Doppler effect being implemented. If the controller 5 of the nuclear reactor 11 detects that the average reactor core temperature is below a predetermined certain temperature (Yes at step S13), operation is stopped (step S14) and an inspection is conducted. Regular cyclic operation periods (such as Cycle 1 in FIG. 6) may be set as desired (for example, one year, five years, or 10 years). The operation may be stopped at any desired time. If the controller 5 detects that the average reactor core temperature is not below the predetermined certain temperature (No at step S13), operation is continued. The nuclear reactor 11 stops operation with the controller 5 controlling the rotational positions of the control parts 4 (step S14). After the inspection, the nuclear reactor 11 starts operation with the controller 5 controlling the rotational positions of the control parts 4. At this start of operation, the controller 5 controls the rotational positions of the control parts 4 so that the neutron absorbers 4A can be moved further away from the nuclear fuel bodies 1A than during the above operation period. That is, in the nuclear reactor 11, the neutron absorbers 4A are made further away from the nuclear fuel bodies 1A than in the last operation period, whereby excess reactivity is added and the reactivity of the nuclear fuel bodies 1A increases. The reactor core temperature that has decreased in the last operation period can be thus raised. Thus, the nuclear reactor 11 can extract the same amount of heat as in the last operation period. Furthermore, in the same manner as at step S12, the nuclear reactor 11 controls the criticality solely with a decrease in the reactor core temperature due to the Doppler effect throughout an operation period where the fuel portion 1 is in the critical state. The nuclear reactor 11 in the present embodiment then undergoes the following process after Cycle 1, which is a periodic operation period, operation is restarted after the rotational positions of the control parts 4 are controlled following the inspection conducted as described above, and thus, as in Cycles 2 to 6 similarly to Cycle 1 as illustrated in FIG. 6, operation and control on the rotational positions of the control parts 4 are implemented that depend solely on the Doppler effect.

As described above, the nuclear reactor 11 in the present embodiment includes the fuel portion 1 being the reactor having the nuclear fuel bodies 1A, the shielding portion 2 that covers all over the outer sides of the fuel portion 1 to shield against radiations generated from the fuel portion 1, and the thermal conduction parts 3 configured to transfer heat that has generated in the fuel portion 1 to the exterior of the shielding portion 2. Furthermore, the nuclear fuel bodies 1A are designed to contain a fissile material with a weight density of not less than 5% by weight throughout each operation period of the nuclear reactor 11.

Thus, designing the nuclear fuel bodies 1A to contain a fissile material with a weight density of not less than 5% by weight enables the nuclear reactor 11 to control the criticality solely with a decrease in the reactor core temperature due to the Doppler effect throughout each operation period. As a result, according to the nuclear reactor 11 in the present embodiment, heat can be stably extracted with criticality control that is easier than, for example, criticality control using control rods and boron as in the case of a light water reactor. Reliability can be thereby improved.

Furthermore, in the nuclear reactor 11 in the present embodiment, the temperature of the reactor core is set to be not less than 350° C. throughout each operation period.

Thus, setting the reactor core temperature as above enables the nuclear reactor 11 in the present embodiment to perform stable criticality control solely with a decrease in the reactor core temperature due to the Doppler effect throughout each operation period. As a result, according to the nuclear reactor 11 in the present embodiment, heat can be comparatively stably extracted with easy criticality control.

Furthermore, in the nuclear reactor 11 in the present embodiment, thermal output and each operation period are limited so that the depleted amount of fissile material depleted due to operation is not less than one third of the amount thereof at the start of operation. In the nuclear reactor 11 in the present embodiment, thermal output can be suppressed by solid thermal conduction or fluid thermal conduction using, for example, heat pipes in the thermal conduction parts 3. In the nuclear reactor 11 in the present embodiment, the operation period can be limited by controlling the rotational positions of the control parts 4 at the start of corresponding operation so that the reactor core temperature can be as described above for each one of the cycles.

Thus, the feasibility of criticality control that depends solely on the Doppler effect throughout each operation period can be enhanced by limiting the thermal output and the operation period so that the amount of fissile material deleted due to corresponding operation of the nuclear reactor 11 is not less than one third of the amount thereof at the start of operation.

Furthermore, the nuclear reactor 11 in the present embodiment includes the fuel portion 1 being the reactor core having the nuclear fuel bodies 1A, the shielding portion 2 covering all over the outer sides of the fuel portion 1 to shield against radiations generated from the fuel portion 1, and the thermal conduction parts 3 configured to transfer heat that has generated in the fuel portion 1 to the exterior of the shielding portion 2. Throughout each operation period, an operation cycle is continued according to decrease of fission reactions due to neutron capture in the resonance region after the temperature of the nuclear fuel bodies 1A increases to a certain value. The operation period continues until the temperature of the nuclear fuel bodies 1A decreases to a certain value.

Thus, according to the nuclear reactor 11 in the present embodiment, stable criticality control can be performed throughout the operation period solely with a decrease in the reactor core temperature due to the Doppler effect. As a result, according to the nuclear reactor 11 in the present embodiment, heat can be extracted stably with easy criticality control, and reliability can be improved.

Furthermore, the nuclear reactor 11 and the control method for the nuclear reactor 11 according to the present embodiment each include the control parts 4 provided such that the neutron absorbers 4A are able to be close to or away from the fuel portion 1. In accordance with a decrease in the reactor core temperature, the neutron absorbers 4A are made further away from the fuel portion 1 at the start of operation after operation is stopped than in the last operation period.

Therefore, in the nuclear reactor 11 in the present embodiment, when the reactor core temperature has decreased below the predetermined value in the last operation period, the control parts 4 are controlled, for example, at the start of operation after stopping operation for inspection, so as to make the neutron absorbers 4A further away from the fuel portion 1 than in the preceding operation period, and thus the reactor core temperature that has decreased in the preceding operation period can be increased. As a result, according to the nuclear reactor 11 in the present embodiment, the same amount of heat as in the preceding operation period can be extracted.

In the nuclear reactor 11, the thermal conduction parts 3 transfer heat from the nuclear fuel bodies 1A to the exterior of the shielding portion 2 by solid thermal conduction.

Therefore, the nuclear reactor 11 in the present embodiment can transfer the heat of nuclear fuel bodies 1A to the exterior of the shielding portion 2 by solid thermal conduction, thereby being able to extract heat while preventing radiation leakage. The nuclear reactor 11 thus ensure a high output temperature. Moreover, the nuclear reactor 11 in the present embodiment conducts the heat of nuclear fuel bodies 1A to the exterior of the shielding portion 2 by solid thermal conduction where thermal conductivity is lower than fluid thermal conduction. Thus, the nuclear reactor 11 can enhance the feasibility of criticality control that depends solely on the Doppler effect throughout each operation period.

In the nuclear reactor 11 in the present embodiment, the shielding portion 2 includes a reflective function that reflects radiation.

Therefore, the nuclear reactor 11 in the present embodiment can ensure the reactivity of the nuclear fuel bodies 1A due to the radiation reflection function of the shielding portion 2. As a result, the nuclear reactor 11 in the present embodiment can enhance the feasibility of criticality control that depends solely on the Doppler effect throughout each operation period.

In the nuclear reactor 11 in the present embodiment, the fuel portion 1 has the support 1B containing a moderator and covering all over outer sides of the nuclear fuel bodies 1A.

Therefore, the nuclear reactor 11 in the present embodiment stabilizes the reactivity of the nuclear fuel bodies 1A using the moderator. As a result, the nuclear reactor 11 in the present embodiment can enhance the feasibility of criticality control that depends solely on the Doppler effect throughout each operation period.

Furthermore, the nuclear reactor 11 in the present embodiment performs criticality control throughout each operation period solely with a decrease in the reactor core temperature due to the Doppler effect. Furthermore, the control method for the nuclear reactor 11 includes controlling criticality throughout an operation period in such a manner as to maintain constant criticality by lowering a reactor core temperature of the fuel portion 1 having the nuclear fuel bodies 1A.

Therefore, according to the nuclear reactor 11 and the control method for the nuclear reactor 11, heat can be extracted stably with easy criticality control, and reliability can be improved.

### Reference Signs List

1 FUEL PORTION (REACTOR CORE)
1A NUCLEAR FUEL BODY
2 SHIELDING PORTION
3 THERMAL CONDUCTION PART
4 CONTROL PART
4A NEUTRON ABSORBER
11 NUCLEAR REACTOR

1. A nuclear reactor comprising:
a reactor core having a nuclear fuel body;
a shielding portion that covers all over outer sides of the reactor core to shield against radiations generated from the reactor core; and
a thermal conduction part that transfers heat generated in the reactor core to exterior of the shielding portion, wherein
throughout an operation period, the nuclear fuel body contains a fissile material with a weight density of not less than 5% by weight and a temperature of the reactor core is set to be not less than 350° C. , and
thermal output and the operation period are limited so that an amount of the fissile material depleted is not less than one third of an amount of the fissile material at start of operation.

2. (canceled)

3. (canceled)

4. A nuclear reactor comprising:
a reactor core having a nuclear fuel body;
a shielding portion that covers all over outer sides of the reactor core to shield against radiations generated from the reactor core; and
a thermal conduction part that transfers heat generated in the reactor core to exterior of the shielding portion, wherein
throughout an operation period, an operation cycle is continued according to decrease of fission reactions due to neutron capture in a resonance region after a temperature of the nuclear fuel body increases to a certain value, the operation cycle continuing until the temperature of the nuclear fuel body decreases to a certain value.

5. The nuclear reactor according to claim 4, further comprising a control part that includes a neutron absorber provided such that the neutron absorber is able to be close to or away from the reactor core, wherein, when operation is started after operation is stopped, the neutron absorber is made further away from the reactor core than in the last operation period.

6. The nuclear reactor according to claim 4, wherein the thermal conduction part conducts heat of the nuclear fuel body to the exterior of the shielding portion by solid thermal conduction.

7. The nuclear reactor according to claim 4, wherein the shielding portion includes a reflective function that reflects radiation.

8. The nuclear reactor according to claim 4, wherein the reactor core includes a moderator covering all over outer sides of the nuclear fuel body.

9. The nuclear reactor according to claim 4, performing criticality control solely with a decrease in temperature of a reactor core due to the Doppler effect throughout the operation period.

10. A control method for a nuclear reactor that includes a reactor core having a nuclear fuel body, a shielding portion that covers all over outer sides of the reactor core to shield against radiations generated from the reactor core, and a thermal conduction part that transfers heat generated in the reactor core to exterior of the shielding portion, the control method comprising continuing, throughout an operation period, an operation cycle according to decrease of fission reactions due to neutron capture in a resonance region after a temperature of the nuclear fuel body increases to a certain value, the operation cycle continuing until the temperature of the nuclear fuel body decreases to a certain value.

11. The control method for a nuclear reactor according to claim 10, wherein
a neutron absorber is provided so as to be able to be close to or away from the reactor core, and
when operation is started after operation is stopped, the neutron absorber is made further away from the reactor core than in the last operation period.

12. The nuclear reactor according to claim 1, wherein the thermal conduction part conducts heat of the nuclear fuel body to the exterior of the shielding portion by solid thermal conduction.

13. The nuclear reactor according to claim 1, wherein the shielding portion includes a reflective function that reflects radiation.

14. The nuclear reactor according to claim 1, wherein the reactor core includes a moderator covering all over outer sides of the nuclear fuel body.

15. The nuclear reactor according to claim 1, performing criticality control solely with a decrease in temperature of a reactor core due to the Doppler effect throughout the operation period.
